(19) United States
(12) Patent Application Publication
(10) Pub. No.: US 2026/0018175 A1
(43) Pub. Date: Jan. 15, 2026

(54) ANNOTATING AUTOMATIC SPEECH RECOGNITION TRANSCRIPTION

(71) Applicant: GOOGLE LLC, Mountain View, CA (US)

(72) Inventors: Dimitri Kanevsky, Ossining, NY (US); Artem Dementyev, Boston, MA (US); Sagar Savla, San Francisco, CA (US)

(21) Appl. No.: 19/135,660

(22) PCT Filed: Dec. 6, 2022
(86) PCT No.: PCT/US2022/081011

§ 371 Date: Jun. 4, 2025

(51) Int. Cl. G10L 15/26; G06F 40/58; G10L 21/0208; G10L 21/0216

(52) U.S. Cl. CPC G10L 15/26; G06F 40/58; G10L 21/0208; G10L 2021/02161

(57) ABSTRACT

In various implementations. audio data that captures a spoken utterance of a first user is received. The audio data being is generated by one or more microphones of a transcription device and is received while at least one first signal, rendered by a first signaling device responsive to a determination that the first user is speaking. is received by the transcription device. A transcription comprising recognized text from the spoken utterance of the first user is generated based on performance of automatic speech recognition on the audio data, and is annotated to indicate that the recognized text from the spoken utterance of the first user is associated with a first identifier corresponding to the at least one first signal, based at least in part on receiving the audio data while receiving the at least one first signal. The annotated transcription can be provided for output.

### BACKGROUND

Speaker diarization is a branch of audio signal analysis that involves portioning an input audio stream into homogenous segments according to speaker identity. It answers the question of “who spoke when” in a multi-speaker environment. For example, speaker diarization can be utilized to identify that a first segment of an input audio stream is attributable to a first human speaker (without necessarily identifying who the first human speaker is), a second segment of the input audio stream is attributable to a disparate second human speaker, a third segment of the input audio stream is attributable to the first human speaker, etc.

An automatic speech recognition (ASR) engine may be used to process audio data that captures a spoken utterance of a user and generate ASR output, such as a transcription (i.e., a sequence of term(s) and/or other token(s)) of the spoken utterance. In some cases, speaker diarization may be used, for example, to enhance readability of an automatic speech transcription by indicating which parts of the transcription belong to each speaker identity.

In an example application, a user may use automatic speech transcriptions to aid in participating in conversations with other people. However, in environments where there are a plurality of people speaking, it may be difficult to follow the conversation(s) in the automatic speech transcription. Whilst speaker diarization could potentially help to enhance the readability of the transcription, many automatic real time transcription systems are not capable of indicating a change in speaker identity. In addition or alternatively, many real time speaker diarization systems that have been proposed for use in indicating changes in speaker identity in a real time transcription, can suffer from one or more drawbacks. For example, some can fail to accurately differentiate between human speakers in various situations such as in noisy environments and/or when speaker(s) have similar voice characteristics. As another example, some can require utilization of a relatively large neural network model, which can require significant memory and/or processor resource(s) during utilization. This can be particularly problematic, for example, when such a neural network model is to be utilized by a client device, with limited resources, that is also performing ASR. For instance, some client devices can lack the resources to perform both ASR and speaker diarization utilizing a diarization neural network model and/or can utilize significant power resources in performing speaker diarization utilizing a diarization neural network model. As yet another example, some can be unable to indicate speaker identity for only a subset of speakers in an environment (e.g., provide a transcription and/or annotation(s) for only some of multiple speakers in an environment).

### SUMMARY

Techniques are described herein for providing an annotated automatic speech recognition transcription. Annotation of the transcription can be performed based on receiving, by a transcription device, a signal associated with a particular identifier together with the spoken utterance from a user to be transcribed. The signal can be provided by a signaling device responsive to determining that the user has started speaking. The recognized text of the spoken utterance can then be associated with the particular identifier, and the transcription can be annotated accordingly.

Techniques described herein give rise to various technical advantages and benefits. For instance, use of an additional signal from a signaling device can enable speech to be attributed to respective identities (e.g. speakers) with greater certainty. Furthermore, by attributing spoken utterances in this way, typical computationally expensive speaker diarization need not be performed. As such, automatic speech recognition transcriptions can be accurately annotated for relatively low cost (e.g. in terms of computing resources, processing time, etc.). In some instances, this can allow for annotated transcriptions to be reliably provided in real time and/or to be generated on device(s) with limited resource(s). In addition, in some implementations, it may be determined to only generate, annotate and/or display transcriptions for spoken utterances provided by relevant person(s), e.g., those spoken utterances accompanied by a signal. In this way, readability of the transcription can be improved, and computational resources which would otherwise be consumed in generating, annotating and/or displaying transcriptions for spoken utterances from, for instance, background speakers, can be saved.

In an example implementation, a system can be provided that includes a transcription device and one or more signaling device(s). The transcription device can be set up to transcribe a meeting involving a plurality of participants. The signaling device(s) may be, for instance, mobile device(s), each associated with one of the participants. The signaling device(s) can determine that a respective participant is speaking, for instance based on sensor data from the signaling device and/or an auxiliary device (e.g. earphones worn by the participant). In response, the signaling device(s) can render a signal associated with an identifier. The identifier can be associated with, for instance, the speaker (e.g. “user 1”), an identity of the speaker (e.g. “Steven”), a user account associated with the speaker, the signaling device providing the signal (e.g. “signaling device 1”), etc. The signal can be associated with the first identifier by virtue of having one or more particular attributes which are associated with the first identifier. For example, the particular attribute(s) can include one or more particular frequencies and/or encoded (e.g. using digital encoding) identification information which can be used to identify the first identifier. The signal can be rendered, for instance, as an audio signal via one or more loudspeakers of the signaling device, or as a visual signal via one or more LEDs of the signaling device.

Continuing with the above example implementation, the transcription device can receive (e.g. via one or more microphones or cameras) a signal from a given signaling device simultaneously with a spoken utterance from a respective participant. For instance, the signal may be received at a start and/or end of the spoken utterance, intermittently during receipt of the spoken utterance, and/or continuously during receipt of the spoken utterance. The transcription device can generate a transcription including the spoken utterance, for instance, using automatic speech recognition. As a result of the spoken utterance being received together with the signal, and the signal being associated with the identifier, the spoken utterance may be associated with the first identifier in the transcription. As one example, an annotation corresponding to the first identifier can be provided adjacent to a portion of the transcription, that corresponds to the spoken utterance. As another example, the portion of the transcription can additionally or alternatively be provided in a color and/or a font that corresponds to the first identifier.

In addition, in a scenario including a plurality of speakers, it may be the case that one or more groups of speakers (i.e., two or more speakers) separate into distinct conversations. Speakers may move between the different conversations, start new conversations with a new group, and end existing conversations with existing groups. In this case, spoken utterances received by the transcription device may relate to different and changing conversations, and so a single transcript including all of the spoken utterances may not be particularly readable. As such, in some implementations, groups of speakers can be determined to be “conversational clusters”, and it can be determined which conversational cluster a particular spoken utterance belongs to. The transcription can be annotated to indicate the conversational cluster to which the spoken utterance belongs, such that when the transcription is presented, conversations can be more easily followed (e.g. by rendering spoken utterances of the different conversational clusters separately). The determination of whether a particular speaker is in a conversational cluster may be based, for instance, on whether other speakers speak at the same time as the particular speaker (i.e., indicating that the other speakers are not in the same conversational cluster as the particular user).

In some implementations, the transcription can be rendered as output on one or more displays (e.g. of the transcription device or another device associated with the listener). For instance, the transcription can be rendered in a streaming manner (e.g. in or close to real-time). Annotations in the transcript can be, for instance, represented by rendering recognized text from a spoken utterance with a color associated with a respective identifier. One or more attributes of the color, for instance intensity, can be modified based on the level of confidence of the association between the recognized text and the identifier. In cases where plural identifiers are associated with a particular section of recognized text (e.g. if more than one signal was received when the respective spoken utterance was received), the text may be rendered to have a combination of colors associated with the plural identifiers. In some additional or alternative implementations, the transcription may be stored for later use.

In some implementations, the transcription device can determine positional information (e.g. a distance and/or direction) of the speaker and/or the signaling device relative to the transcription device. For instance, the transcription device can include a beamforming microphone array capable of determining a direction from which an audio signal is received. As another example, the signal provided by the signaling device may include information indicative of a direction and/or distance between the signaling device and the transcription device (e.g. time distance of arrival (TDOA) localization information). The positional information can be used, for instance, to determine whether or not to perform automatic speech recognition on a particular spoken utterance, whether the spoken utterance should be annotated as being associated with an identifier (even when a signal associated with the identifier is received contemporaneously with the spoken utterance), whether an identifier should be associated with a particular conversational cluster, etc. In some additional or alternative implementations, the transcription can be annotated to indicate the positional information associated with a particular spoken utterance. This may further enhance the readability of the transcription, and allow a user of the transcription to more easily follow the conversation(s) being transcribed.

### BRIEF DESCRIPTION OF THE DRAWINGS

FIG. 1 depicts a scenario in an example environment that demonstrates various aspects of the present disclosure, in accordance with various implementations.

FIG. 2 depicts a flowchart illustrating an example method of generating an annotated transcription, in accordance with various implementations.

FIGS. 3A and 3B depict various non-limiting examples of user interfaces utilized in rendering an annotated transcription, in accordance with various implementations.

FIGS. 4A and 4B depict example methods for practicing selected aspects of the present disclosure

FIG. 5 schematically depicts an example architecture of a computer system.

### DETAILED DESCRIPTION

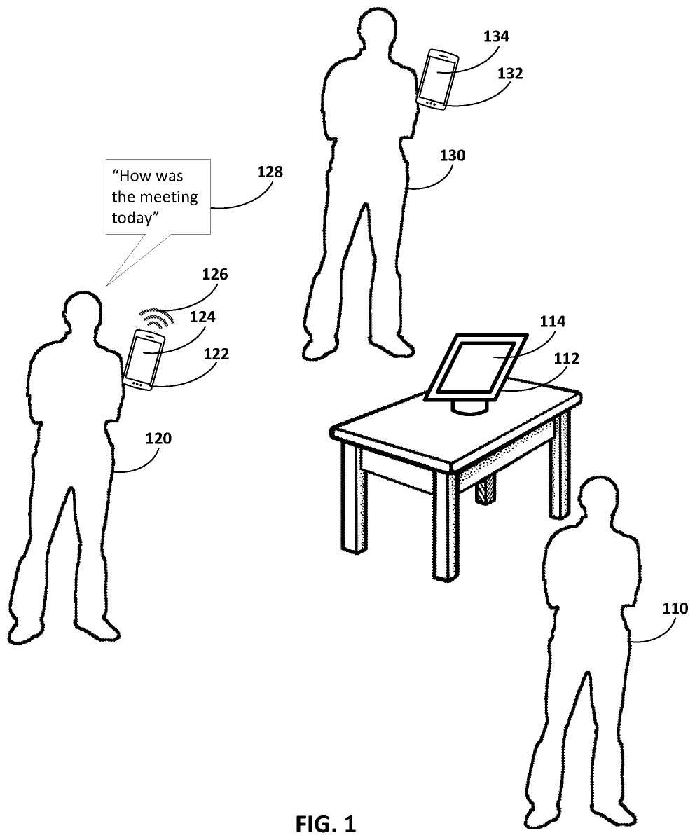

FIG. 1 depicts a scenario in an example environment that demonstrates various aspects of the present disclosure, in accordance with various implementations. The environment includes a plurality of users 110, 120, 130 engaging in a conversation. As shown in FIG. 1, a first user 110 may optionally be associated with a transcription device 112. However, it will be appreciated that the transcription device 112 need not be associated with any users. For instance, in an example where the transcription device 112 is provided in a conference room and configured to transcribe a meeting between a plurality of participants, the transcription device 112 may not be associated with any particular user. A second user 120 may be associated with signaling device 122 and a third user 130 may be associated with signaling device 132. Although a first user 110, a second user 120, and a third user 130 are depicted in FIG. 1, it will be appreciated that the system may operate with any number of users. In addition, although a single transcription device 112, associated with the first user 110, is depicted in FIG. 1, it will be appreciated that there may be a plurality of transcription devices 112, and each transcription device 112 may not be associated with any particular user, or may be associated with any number of users. Similarly, there may be any number of signaling devices 122, 132 present in the environment, and each may be associated with any number of users.

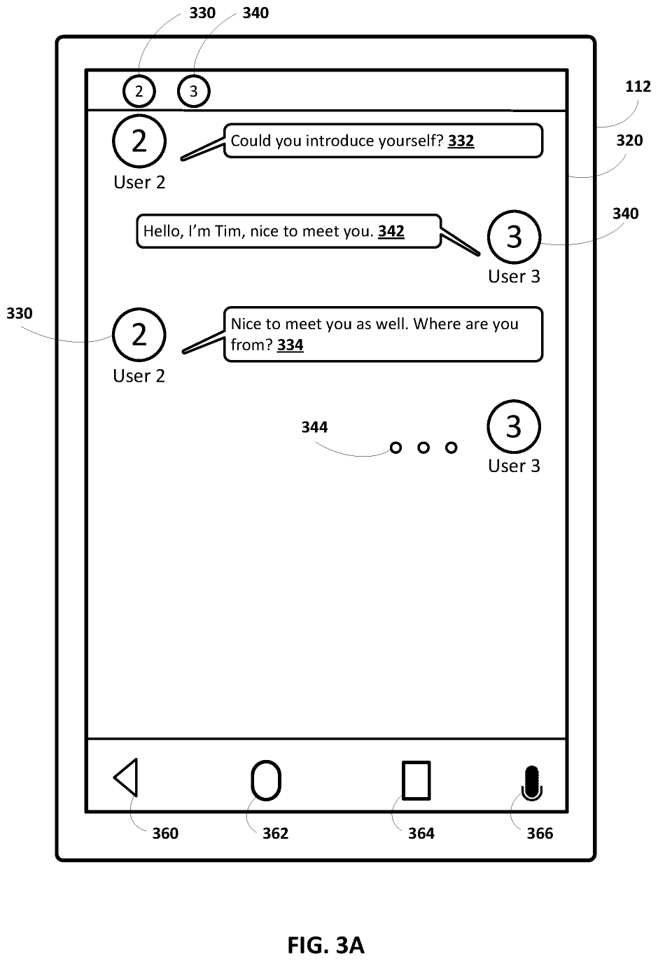

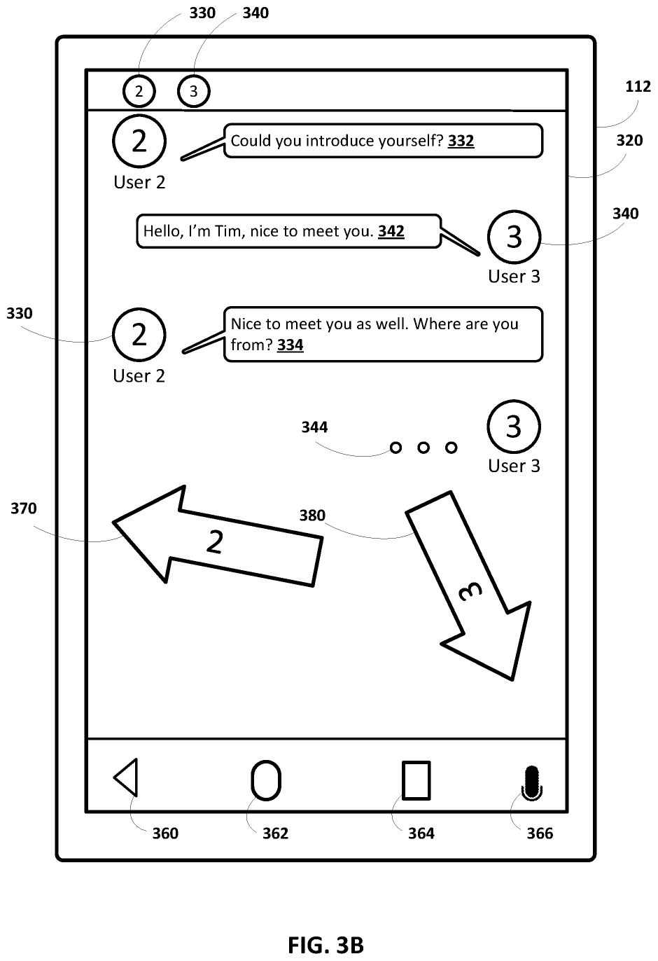

The transcription device 112 may be any suitable type of device. For instance, as illustrated in FIG. 1, the transcription device 112 may be provided as a desktop computer. However, it will be appreciated that the transcription device 112 is not limited to this and may be provided as a mobile device, a laptop computer, a tablet computer, a conferencing system, a wearable device such as a smart watch, earphones, a headset, smart glasses, a badge device, etc. In some implementations, the transcription device 112 may include a display 114. The display 114 can output the annotated transcription, for instance, via a user interface (such as user interface 320 depicted in FIGS. 3A and 3B). In some implementations, the display 114 may be touch sensitive to allow for user input. The transcription device 112 includes one or more microphones. The one or more microphones can be used to detect sounds occurring in the environment (e.g. a spoken utterance 128 from the second user 120, a signal 126 from the signaling device 122, background noise, etc.) and responsively generate audio data. The transcription device 112 may additionally include one or more input and/or output interfaces to enable a user to interact with the transcription device 112 (e.g. keyboard, mouse, hardware speakers, etc.). In some implementations, one or more operations described as being performed by the transcription device 112 can be performed by a remote computing device (e.g. a server) that is in network communication with the transcription device 112. In addition, in some implementations, the transcription device 112 may not include a display 114. As such, the transcription device can provide the annotated transcription to another device for display, perhaps at a later time (i.e., not in real time).

The signaling device 122 may be any suitable type of device. For instance, as illustrated in FIG. 1, the signaling device 122 may be provided as a mobile device. However, it will be appreciated that the signaling device 122 is not limited to this and may be provided as a desktop computer, laptop computer, tablet computer, etc. In some implementations, the signaling device 122 may be provided as a wearable device such as a smart watch, earphones, a headset, smart glasses, a badge device, etc. In addition, each of the signaling devices 122, 132 in the environment may be of the same type, or may be of different types.

The signaling device 122 may include a display 124. Similarly, signaling device 132 may include a display 134. In some implementations, the signaling device 122 and/or signaling device 132 may be capable of operating in a similar way as described for the transcription device 112. For instance, the signaling device 122 and/or signaling device 132 may render the annotated transcription on the respective displays 124, 134 via a user interface (e.g. the user interface 320 as described in relation to FIGS. 3A and 3B).

In some implementations, the environment includes one or more auxiliary devices (not shown). An auxiliary device can be in communication with a respective signaling device 122. The auxiliary device can provide sensor data to the respective signaling device. The sensor data can be used to determine whether or not a user is speaking. Additionally or alternatively, the auxiliary device can process the sensor data to determine whether a user is speaking. Responsively, the auxiliary device can provide to the signaling device 122 an indication that the user is speaking. The auxiliary device may be, for instance, a wearable device such as a smart watch, earphones, a headset, smart glasses, a badge device, etc. In this way, the auxiliary device may be of a form more suitable for detecting whether a user is speaking, allowing for conventional devices to be used as the signaling device 122 (e.g. a smartphone).

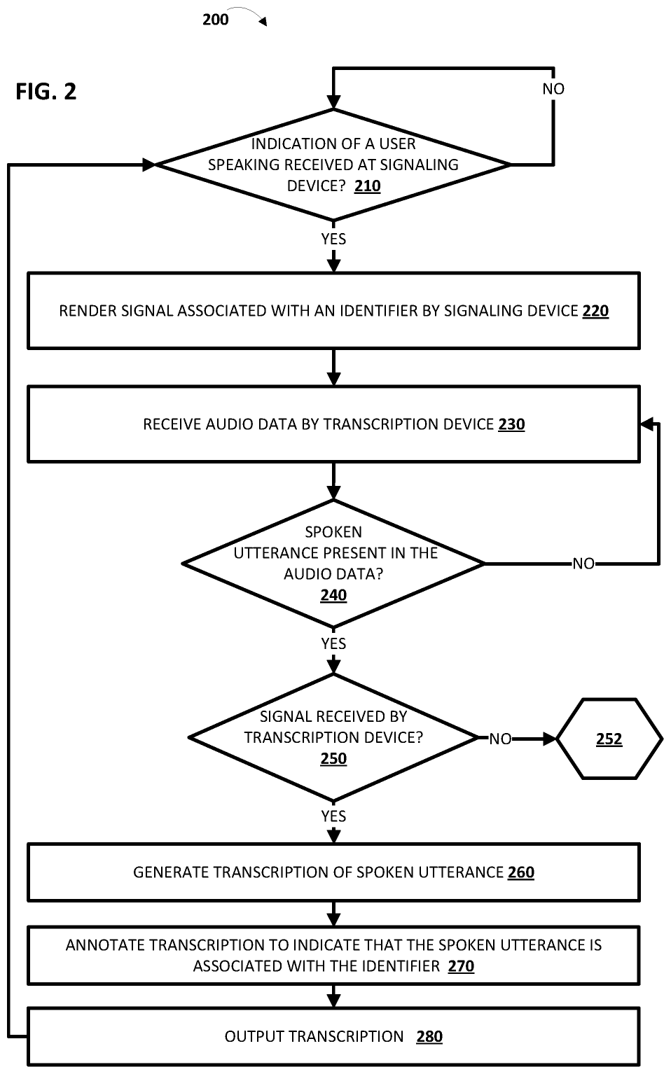

FIG. 2 depicts a flowchart illustrating an example method 200 of generating an annotated transcription, in accordance with various implementations. For convenience and not by way of limitation, the example method 200 of FIG. 2 will be described herein with reference to the scenario depicted in FIG. 1.

As illustrated in FIG. 1, the second user 120 may utter the phrase 128 “How was the meeting today”. As a result, in block 210, the signaling device 122 may receive an indication of user 120 speaking. The indication of the user 120 speaking can be received based on the signaling device 122 processing sensor data. The sensor data may be captured by sensors of the signaling device 122 and/or sensors of an auxiliary device in communication with the signaling device 122, as described previously. For instance, the sensors may capture sound data including a spoken utterance, image data capturing the user's mouth moving, infrared data capturing the user's mouth moving, vibration data from the user's body (e.g. face, neck, chest, etc.) indicative of the user 120 speaking, etc. In some implementations, the auxiliary device can provide the indication that the user 120 is speaking based on captured data from the auxiliary device. As a result of the indication of the user 120 speaking being received, the operation can proceed to block 220. If an indication of the user 120 speaking is not received, the operation can loop back to block 210, until an indication of the user 120 speaking is received. In other words, the signaling device 122 may continue to monitor for an indication that the user 120 is speaking.

In block 220, responsive to receiving the indication of the user 120 speaking, the

signaling device renders a signal 126 associated with an identifier. The signal can be associated with the first identifier by virtue of having one or more particular attributes which are associated with the first identifier. For example, the particular attribute(s) can include one or more particular frequencies and/or encoded (e.g. using digital encoding) identification information which can be used to identify the first identifier. The signal 126 may be rendered, for instance, as an audio signal (e.g. via one or more loudspeakers of the signaling device 122), or as a visual signal (e.g. via one or more LEDs of the signaling device 122). The identifier can be associated with, for instance, the user 120 providing the spoken utterance (e.g. “user 2”), an identity of the user 120 (e.g. “Steven”), a user account associated with the user 120, the signaling device 122 providing the signal 126 (e.g. “signaling device 1”), etc.

The signal 126 may be rendered by the signaling device 122 continuously throughout substantially the duration of the spoken utterance 128. For instance, the signal 126 can be rendered continuously whilst sensor data is indicative of the user currently speaking. As another example, the rendering of the signal 126 can be started when it is detected that a user has started speaking, and ceased when cessation of the user speaking is detected. The signal 126 may also be rendered by the signaling device 122 intermittently during the duration of the spoken utterance 128, at a beginning and/or end of the spoken utterance 128, etc. For instance, the signal 126 can be rendered intermittently whilst sensor data is indicative of the user currently speaking. As another example, the signal 126 can be rendered a first time upon detection of the user speaking and for a second time when cessation of the user speaking is detected. In this way, by causing the signaling device 122 to render the signal 126 only during part of the spoken utterance 128, battery life of the signaling device 122 can be preserved, and a likelihood of the signal 126 interfering with reception of other signals and/or other audio data can be reduced.

In some implementations, the identifier with which the signal 126 is associated can be known to the signaling device 122 in advance of the transcription session. For instance, the identifier may be predetermined by the manufacturer of the signaling device, or may be set by a user ahead of time. Additionally or alternatively, the identifier can be determined based on information received from another device (e.g. transcription device 112 or a remote computing device). For instance, user account information associated with a particular user may be provided to the signaling device. As another example, the identifier can be determined based on information provided during the transcription session. For instance, at the beginning of the transcription session, users may provide identifying information (e.g. a name, an ID number, etc.) to signaling devices 122, 132 and/or transcription devices 112, which can then be stored and/or distributed.

In block 230, the transcription device 112 receives audio data. One or more microphones of the transcription device 112 capture sound occurring in the environment. Responsively, the audio data is generated by the one or more microphones of the transcription device 112.

In block 240, a determination is made as to whether the audio data captures a spoken utterance. This determination may be made based on performance of speech detection in the audio data. For instance, this determination may be made as part of generating a transcription of the spoken utterance, as described in relation to block 260. In some implementations, this determination may be made based on an assumption that if a signal 126 is received from a signaling device 122 together with the audio data, the audio data captures a spoken utterance. In the event that it is determined that there is not a spoken utterance present in the audio data, the transcription device may continue to monitor for spoken utterances present in subsequently received audio data (as depicted by the “NO” path). When it is determined that there is a spoken utterance present in the audio data, operation can proceed to block 250.

In block 250, a determination is made as to whether a signal 126 is received by the transcription device 112. In some implementations, a determination can be made as to whether the signal 126 is received together with the spoken utterance 128 in the audio data. For instance, the signal 126 may be received at a start and/or end of the spoken utterance 128, intermittently during receipt of the spoken utterance 128, and/or continuously during receipt of the spoken utterance 128, etc. If it is determined that no signal 126 was received by the transcription device 112, operation may proceed to block 252. If it is determined that a signal 126 was received by the transcription device 112, operation may proceed to block 260.

In block 252, the transcription device 112 may prevent inclusion of any recognized text from the spoken utterance in the audio data in the annotated transcription. For instance, the transcription device 112 may determine to bypass performance of automatic speech recognition (and/or speech detection in block 240 if block 250 is performed first) on the audio data. As another example, the transcription device 112 may still proceed to block 260 and generate a transcription of the spoken utterance 128. The transcription device 112 may further proceed to block 270 and annotate the transcription to indicate that the spoken utterance is not associated with any identifier, since no signal was received. However, when the annotated transcription (which can include a plurality of transcribed spoken utterances) is output in block 280, the spoken utterance 128 can be omitted by virtue of no signal 126 being received with the spoken utterance 128. In this way, resources which would be consumed in generating and/or presenting recognized text from spoken utterances from, for instance, persons speaking who are not involved in the conversation (and therefore may not be associated with a signaling device to provide a signal to the transcription device 112) can be conserved.

In some implementations, when the annotated transcription is output in block 280, the spoken utterance 128 can still be included. An indication that the spoken utterance 128 is not associated with any particular identifier can also be included. For instance, if the annotated transcription is rendered on a display 114 of the transcription device 112, the color of the recognized text of the spoken utterance 128 may reflect that no identifier is associated with the spoken utterance. In this way, spoken utterances which occurred during the conversation but which were received without a corresponding signal 126 (e.g. because some of the users in the conversation do not have associated signaling devices, because a signal which should have been rendered and received was not received for any reason, etc.) can still be recorded.

In block 260, the transcription device 112 generates a transcription of the spoken utterance 128. Generating the transcription can be based on performance of automatic speech recognition on the audio data. For example, performance of automatic speech recognition can include processing the audio data using speech-to-text model(s), such as a recurrent neural network transducer (RNN-T) or other neural network model(s). The transcription device 112 can determine, using one or more speech recognition models, recognized text corresponding to the spoken utterance in the audio data. The generated transcription can thus include the recognized text from the spoken utterance 128 of the user 120. In some implementations, the automatic speech recognition can be performed locally on the transcription device 112. In some other implementations, the transcription device 112 can cause performance of the automatic speech recognition by one or more remote computing devices in communication with the transcription device 112. In some implementations the identifier associated with the signal 126 may be used in the generation of the transcription of the spoken utterance 128. For instance, the identifier may enable attributes of the speaker of the spoken utterance 128 (e.g. accent, speech impediments, etc.) to be determined. These attributes of the speaker of the spoken utterance can then be taken into account when generating the transcription of the spoken utterance.

In block 270, the transcription is annotated. The transcription can be annotated to indicate that the recognized text of the spoken utterance 128 is associated with a particular identifier. This may be based on the signal 126 received with the spoken utterance 128 being associated with the particular identifier. The transcription may include a plurality of spoken utterances from the users in the environment (e.g. over the course of the transcription session), each having been received with a signal from a signaling device associated with the user providing the spoken utterance. In this case, the transcription can be annotated to indicate that the spoken utterance is associated with respective identifier corresponding to the signal with which it was received. In some implementations, the transcription may be annotated to indicate additional information about the user and/or the first signaling device. For instance, the transcription may be annotated to indicate a determined direction from which the audio data and/or the first signal was received.

In some implementations, the transcription device 112 can determine the first identifier based on attributes of the signal 126. For instance, signals of particular frequencies may be associated with particular identities (e.g. signals with frequencies in a first frequency range may be associated with a first identity, signals with frequencies in a second frequency range may be associated with a second identity, etc.). As another example, signals with particular patterns of intensity modulation may be associated with particular identities (e.g. signals with a constant intensity may be associated with a first identity, signals with an intensity which alternates between a maximum and minimum value at a particular frequency may be associated with a second identity, etc.).

In some implementations, the transcription device 112 can determine the first identifier based on information encoded in the signal 126. For instance, the signal 126 may be encoded, by the signaling device 122 with the first identifier itself, or with information which can be used to retrieve the first identifier (e.g. from the transcription device 112 or from a remote computing device). In other words, the transcription device 112 may determine that the first identifier is associated with the signal 126 based on information encoded in the signal 126. In some implementations, the transcription device 112 can additionally or alternatively determine other information about the user 120 or the signaling device 122 based on information encoded in the signal 126. As an example, the transcription device 112 can determine time distance of arrival (TDOA) localization information encoded in the signal 126. The transcription device 112 can then use the TDOA localization information when annotating the transcription.

In some implementations, the transcription device 112 can determine the first identifier based on a previous spoken utterance from the user 120 received while receiving a previous instance of the signal 126. For instance, the previous spoken utterance can include the identifier for the user 120. As an example, at the beginning of a conversation, each participant of the conversation may announce their name. Responsive to the utterance of a name, a participant's respective signaling device 122 may render a corresponding signal 126, where the signal 126 can be, for instance, associated with the participant's signaling device 122. As a result of receiving a signal 126 (e.g. associated with a particular signaling device) along with the utterance of a particular name, the signal 126 can be associated with the particular name for later use in annotating spoken utterances by a given user with their name.

In block 280, the annotated transcription is output by the transcription device 112. For instance, the transcription device 112 can render the annotated transcription on the display 114 of the transcription device 112. Additionally or alternatively, the transcription device 112 can provide the annotated transcription for display by one or more other devices, such as signaling device 122 and signaling device 132. The annotated transcription may be rendered in a streaming manner. For instance, the annotated transcription may be rendered on the display device during a conversation session with minimal delay (e.g. in or near to real time), such that a user viewing the annotated transcription as it is being rendered can follow the conversation. In some implementations, the transcription device 112 can store the annotated transcription (or provide the annotated transcription for storage by one or more other devices, such as signaling device 122, signaling device 132, a remote computing device, etc.), for later viewing.

In some implementations, one or more graphical elements (such as the recognized text from the spoken utterance 128 of the user 120) is rendered to include a color associated with the identifier. As an example, text recognized from speech received from the second user 120 may be rendered in a red color, and text recognized from speech received from the third user 130 may be rendered in a blue color. In some cases, text recognized from speech which is not associated with any particular user (e.g. because the speech was received without a corresponding signal from a signaling device) may be rendered in a particular color (e.g. gray), or may not be rendered at all.

In some implementations, a confidence that the spoken utterance of the user 120 is associated with a particular identifier can be determined. For instance, when the signal is provided as an audio signal, background noise (e.g. wind noise, signals from other signaling devices, etc.) may be received along with the signal 126, which may reduce the confidence that the spoken utterance 128 of the user 120 is actually associated with the identifier. In some cases, the direction from which the spoken utterance 128 and/or the signal 126 is received may be used in determining the confidence that the spoken utterance 128 of the user 120 is associated with the identifier. For instance, if it is determined that the direction from which the signal 126 is received is significantly different from the direction from which the spoken utterance 128 is received, there may be a low confidence that the spoken utterance 128 should be associated with the signal 126 (e.g. because the spoken utterance 128 may be being provided by a person other than the user 120 associated with the signaling device 122). The transcription can be annotated to indicate this confidence. As such, when output, recognized text in the transcription can be rendered to indicate the confidence that the recognized text belongs to a particular identifier. For instance, the confidence can be used to determine an intensity of color, and the recognized text can be rendered with the color at the determined intensity of color. Following the earlier example, if the confidence that a particular passage of recognized text is received from the user 120 is 80%, the system may cause the particular passage of text to be rendered in the red color with an intensity of 80%. Although intensity of color is provided as an example here, it will be appreciated that the confidence may be presented in any suitable way.

In some implementations, it may be determined that a particular spoken utterance could have been received from more than one user. For instance, multiple signals associated with different identifiers may be received together with the spoken utterance. In this case, it may not be possible to associate a single identifier with the spoken utterance. As such, the system may cause the color of the recognized text resulting from the spoken utterance to be rendered with a color determined from a combination of the colors associated with the different identifiers. Following the example above, in the event that the spoken utterance 128 is associated with both the second user 120 and the third user 130, the recognized text of the spoken utterance 128 may be rendered to have a color which is a combination of red and blue. In some implementations, the contribution of each of the colors in the combination of colors may be determined based on a confidence that the spoken utterance is associated with a particular identifier.

In some implementations, additional information about the user 120 or the signaling device 128 may be rendered. For instance, information associated with the identity of the user 120 or the signaling device 128 may be rendered along with corresponding recognized text (for instance, as depicted in FIGS. 3A and 3B). As another example, an indication of a determined direction and/or distance of the user 120 and/or the signaling device 122 may be presented (for instance, as depicted in FIG. 3B).

Although operations are generally described herein as being performed by the transcription device 112 or the signaling device 122, it will be appreciated that one or more operations can be performed by other devices, such as one or more remote computing devices (e.g. servers, cloud computers, etc.), or can be distributed among plural devices. For instance, although the transcription device 112 is described as performing automated speech recognition on the audio data to determine recognized text corresponding to a spoken utterance in the audio data, in some implementations, this may be performed by one or more remote computing devices. In this way, at least some tasks (e.g. the more computationally intensive tasks) can be outsourced to other devices, which may have more available computing resources. This may improve the speed of the techniques described herein (e.g. allowing for real time rendering of the annotated transcription), and/or reduce the resource requirements of the signaling device 122 and/or the transcription device 112.

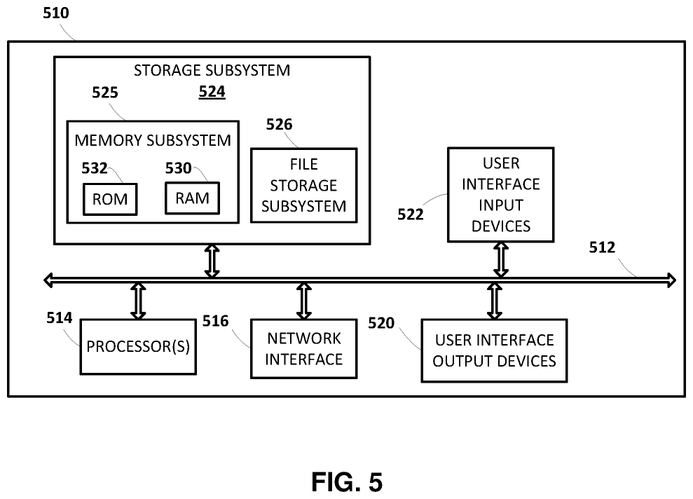

Referring to FIGS. 3A and 3B, various non-limiting examples of user interfaces utilized in rendering an annotated transcription, in accordance with various implementations, are illustrated. The transcription device 112 of first user 110 of FIG. 1 is depicted and includes the user interface 320. Although the techniques of FIGS. 3A and 3B are depicted as being implemented by the transcription device 112 of FIG. 1, it should be understood that this is for ease in explanation only and is not meant to be limiting. For example, the techniques of FIGS. 3A and 3B can additionally and/or alternatively be implemented by one or more other devices (e.g., signaling devices 122 and 132 of FIG. 1, computer system 510 of FIG. 5, computing devices of other users, and/or other computing devices). This may be the case, for instance, if the transcription is stored and viewed at a later time. The user interface 320 of the transcription device 112 includes various system interface elements 360, 362, 364 (e.g., hardware and/or software interface elements) that may be interacted with by the first user 110 to cause the transcription device 112 to perform one or more actions. Further, the user interface 320 of the transcription device 112 enables the first user 110 to interact with content rendered on the user interface 320 by touch input (e.g., by directing user input to the user interface 320 or portions thereof) and/or by spoken input (e.g., by selecting microphone interface element 366—or just by speaking without necessarily selecting the microphone interface element 366 (i.e., an automated assistant executing at least in part on the signaling device 122 may monitor for one or more terms or phrases, gesture(s) gaze(s), mouth movement(s), lip movement(s), and/or other conditions to activate spoken input)).

In some implementations, the user interface 320 of the transcription device 112 can include graphical elements identifying each of the participants in the conversation. The participants in the conversation can be identified in various manners, such as any manner described herein (e.g., receiving signals associated with identifiers along with the spoken utterances from participants). As depicted throughout FIGS. 3A and 3B, graphical element 330 corresponds to the second user 120, and graphical element 340 corresponds to the third user 130. In some versions of those implementations, these graphical elements that identify participants in the conversation can be visually rendered along with corresponding transcriptions of user spoken input of participants in the conversation. In some additional and/or alternative versions of those implementations, these graphical elements that identify participants in the conversation can be visually rendered at a top portion of the user interface 320 of the transcription device 112. Although these graphical elements are depicted as being visually rendered at the top portion of the user interface 320 of the transcription device 112, it should be noted that is not meant to be limiting, and that these graphical elements can be rendered on a side portion of the user interface 320 or a bottom portion of the user interface 320. In some implementations, the participants in the conversation (and their corresponding spoken utterances) may be additionally or alternatively represented by rendering one or more graphical elements (e.g. the recognized text of their spoken utterances, graphical elements 330 340, etc.) in particular colors associated with the participants.

Referring initially to FIG. 3A, the annotated transcription can be rendered on the user interface 320 of the transcription device 112 over the course of the transcription session. For example, the transcription device 112 can detect the spoken input 332 (which may also be referred to as a spoken utterance) of “Could you introduce yourself?” along with a signal associated with an identifier indicating that the second user 120 provided the spoken input 332. Responsively, the spoken input 332 can be rendered at the transcription device 112 along with the graphical element 330 corresponding to the second user 120. Subsequently, the transcription device 112 can detect spoken input 342 from the third user 130 of “Hello, I'm Tim, nice to meet you” along with a signal associated with an identifier indicating that the third user 130 provided the spoken input 342. Responsively, the spoken input 342 can be rendered at the transcription device 112 along with the graphical element 340 associated with the third user 130. Further, the second user 120 can provide another spoken input 334 of “Nice to meet you as well. Where are you from?”, which can also be rendered at the transcription device 112.

As the transcription device 112 detects further spoken input an indication that the further spoken input is incomplete may be provided (e.g. by ellipses 344).

In some implementations, an indication of the direction from which the spoken input and/or the signal is received can be provided. For example, as shown in FIG. 3B, a first shape 370 and a second shape 380 can indicate a determined direction relating to the second user 120 and the third user 130 respectively. Although the shapes shown in FIG. 3B are arrow shapes, it will be appreciated that any shape could be used, for instance, a circular shape along an edge of the user interface 320 could be used to indicate a determined direction. The shapes 370, 380 may, for instance, appear only whilst a respective user is speaking. As another example, the shapes 370, 380 may remain visible even when the users are not speaking. Further, although the shapes 370, 380 are shown as being separate from the transcribed user inputs 332, 342, 334, in some cases, they may be presented together as a single graphical element.

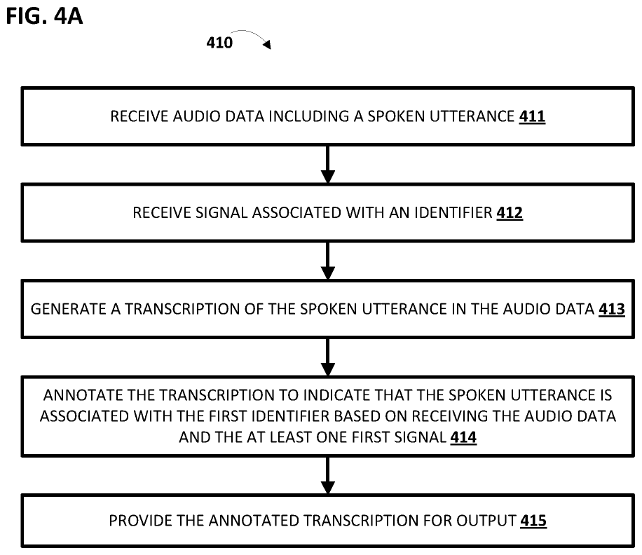

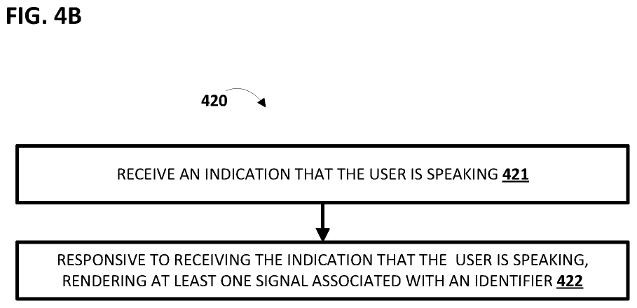

FIG. 4A depicts an example method for practicing selected aspects of the present disclosure. For convenience, the operations of the flowchart are described with reference to a system that performs the operations. This system may include various components of various computer systems. For instance, some operations may be performed at transcription device 112, while other operations may be performed by one or more components of a remote computing system. Moreover, while operations of method 410 are shown in a particular order, this is not meant to be limiting. One or more operations may be reordered, omitted or added.

At block 411 the system receives audio data that captures a spoken utterance of a first user. The audio data can be generated by one or more microphones of the transcription device 112.

In some implementations, the one or more microphones of the transcription device 112 may include a plurality of spatially distributed microphones (e.g. a beamforming microphone array). The system can determine, based on a relative signal strength of the received audio data received at each one of the plurality of spatially distributed microphones, a direction from which the audio data was received. This information can be used to, for instance, focus the listening of the microphones of the transcription device 112 in the direction of a user such that background noise can be minimized in the audio data. Alternatively or additionally, the determined direction can be used to determine whether to process and/or display received spoken utterances. For instance, spoken utterances received from a direction different (e.g. greater than a threshold difference) to a known direction of a user (e.g. based on a determined direction of prior speech and/or on a determined direction of a signal) may not be further processed. This may prevent background speech from being presented in the transcription and also from resources from being wasted in doing so. As another example, the determined direction may be indicated in the annotated transcription.

At block 412, the system receives at least one first signal by the transcription device 112. The at least one first signal can be received whilst the audio data is received by the spoken utterance. The at least one first signal can be rendered by a first signaling device responsive to a determination that the first user is speaking. The transcription device and the first signaling device may be separate entities (e.g. physically distinct from one another). For instance, the transcription device and the first signaling device may be spaced apart from one another. The at least one first signal may be associated with an identifier. The identifier may be indicative of a user in the environment (i.e., the user providing the spoken utterance), an identity of the user, the signaling device used to render the first signal, etc.

In some implementations, the system determines the first identifier based on attributes of the first signal. For instance, signals of particular frequencies can be associated with particular identities (e.g. signals with frequencies in a first frequency range may be associated with a first identity, signals with frequencies in a second frequency range may be associated with a second identity, etc.). As another example, signals with particular patterns of intensity modulation can be associated with particular identities (e.g. signals with a constant intensity may be associated with a first identity, signals with an intensity which alternates between a maximum and minimum value at a particular frequency may be associated with a second identity, etc.).

In some implementations, the system determines the first identifier based on information encoded in the at least one first signal. For instance, the first signal may be encoded with the first identifier itself, or with information which can be used to retrieve the first identifier (e.g. from the transcription device or from a remote computing device). In other words, the system may determine that the first identifier is associated with the first signal based on information encoded in the first signal. In some implementations, the system may additionally or alternatively determine other information about the first user or the first signaling device based on information encoded in the at least one first signal. As an example, the system may determine time distance of arrival (TDOA) localization information encoded in the first signal. The system may then use the TDOA localization information when annotating the transcription.

In some implementations, the system determines the first identifier based on a previous spoken utterance from the first user received while receiving the at least one first signal. For instance, the previous spoken utterance can include the first identifier for the first user.

In some implementations, the first signal may be received by the transcription device during substantially the entirety of the spoken utterance. In some implementations, the first signal may be received by the transcription device during only part of the spoken utterance, for instance, at a beginning, at an end, intermittently throughout the spoken utterance, etc.

In some implementations, the first signal is received by detecting an audio signal emitted by one or more hardware speakers of the first signaling device. The audio signal may be inaudible to humans. For instance, the audio signal may include ultrasound signals and/or infrasound signals. Use of ultrasound signals may be useful in implementations where the signaling device 122 will largely face towards the transcription device 112 (for instance, if the signaling device 122 is a wearable device having loudspeakers which will largely face forwards with respective to the user 120), since ultrasound signals can be more directional. Use of infrasound signals may be useful in implementations where the signaling device 122 will not be reliably facing towards the transcription device 112, since infrasound signals can be more omnidirectional. The audio signal may be captured in the audio data, e.g. the same audio data capturing the spoken utterance of the user. As such, in order to improve the performance of later automatic speech recognition, the system may filter the audio data to remove the audio signal from the audio data for the automatic speech recognition.

In some implementations, the first signal is received by detecting a visual indicator output by an interface of the first signaling device.

At block 413, the system generates a transcription based on performance of automatic speech recognition on the audio data. The generated transcription may include recognized text from the spoken utterance of the first user. In some implementations, in generating the transcription, the system also translates the recognized text from the spoken utterance of the first user into a different language (e.g. a language nominated by a user of the transcription device).

At block 414, the system annotates the transcription to indicate that the recognized text from the spoken utterance of the first user is associated with a first identifier corresponding to the at least one first signal, based at least in part on receiving the audio data while receiving the at least one first signal. In some implementations, the transcription can be annotated to indicate additional information about the user and/or the first signaling device. For instance, the transcription can be annotated to indicate a direction from which the audio data and/or the first signal was received.

At block 415, the system provides the annotated transcription for output. In some implementations, the annotated transcription may be provided for output by rendering the annotated transcription on a display interface (e.g. display 114 of transcription device 112). The annotated transcription may be rendered on the display interface in a streaming manner. For instance, the annotated transcription may be rendered on the display interface during a conversation with minimal delay (e.g. in or near to real time), such that a user viewing the annotated transcription as it is being rendered can follow the conversation.

In some implementations, the system can determine that the first user is a member of a first conversational cluster from among a plurality of conversational clusters. This determination may be based at least in part on determining that a spoken utterance of at least one other user overlaps with an earlier spoken utterance of the first user for at least a first threshold period of time. For instance, if it is determined that the first user and the other user consistently talk over one another (i.e., more than would be expected if they were speaking to one another), it may be assumed that they are involved with separate conversations. Similarly, if it is determined that speech of the user does not consistently overlap with speech of another user, it may be assumed that it is more likely that the user is involved in a conversation with that user. Determining that the first user is a member of a first conversational cluster may also be based one or both of a determined distance or direction of the first user. For instance, it may be determined that the user is co-located (i.e., within a threshold distance) with a group of other users, and it may be assumed that it is more likely that the user is in a conversation with this group. The system may annotate the transcription to indicate that the recognized text from the spoken utterance of the first user is part of the first conversational cluster. In this way, the annotated transcription may be output, for example, as separate conversations according to recognized text belonging to each conversational cluster.

The system can dynamically update the conversational cluster to which the first user is determined to belong. For instance, it may be determined that the first user has become a member of a second conversational cluster. For instance, the user may move between conversational clusters, or start new conversational clusters. This updating may be performed in much the same way as described above in relation to initially identifying the conversation cluster of the first user. The transcription can be annotated to reflect the relevant conversational cluster of the first user throughout the transcription session. In some cases, the conversation cluster of each user involved in the transcription session may be recorded.

FIG. 4B depicts an example method 420 for practicing selected aspects of the present disclosure. For convenience, the operations of the flowchart are described with reference to a system that performs the operations. This system may include various components of various computer systems. For instance, some operations may be performed at a signaling device (such as signaling device 122 as depicted in FIG. 1), while other operations may be performed by one or more components of an auxiliary device or a remote computing device. Moreover, while operations of method 420 are shown in a particular order, this is not meant to be limiting. One or more operations may be reordered, omitted or added.

At block 421, the system receives, based on sensor data received from one or more sensors of a signaling device (e.g. a mobile device) and/or an auxiliary device (e.g. a wearable device such as earphones) in communication with the signaling device, an indication that a first user is speaking. The signaling device can process the sensor data itself to generate the indication that the first user is speaking. Alternatively, the auxiliary device can process the sensor data to generate the indication that the first user is speaking.

The sensor data may be of any suitable type to be used to provide an indication that a user is speaking. For instance, the sensor data may include audio data generated by one or microphones, infrared data, vibration data, movement data, etc. The sensor data may be captured by any type of suitable sensor, such as a microphone, a camera, an infrared camera, an inertial measurement unit (IMU), an accelerometer, etc.

At block 422, the system, responsive to receiving the indication that the first user is speaking, renders at least one signal associated with a first identifier. The at least one signal rendered by the system can cause a transcription device 112, receiving the at least one signal and the spoken utterance, to associate the spoken utterance with the first identifier.

In some implementations, the system can receive, based on additional sensor data received from the one or more sensors, an indication that the first user is no longer speaking. In response, the system may cause the rendering of the at least one signal to stop, and/or rendering at least one second signal to indicate that the user is no longer providing the spoken utterance.

In some implementations, the at least one signal includes an audio signal emitted by a hardware speaker of the signaling device. The audio signal may be inaudible to humans. For instance, the audio signal may include ultrasonic frequencies and/or infrasonic frequencies of sound. In some implementations, the at least one signal includes a visual indicator provided by an interface of the signaling device.

In some implementations, the identifier with which the signal is associated may be known to the signaling device in advance of the transcription session. For instance, the identifier may be predetermined by the manufacturer of the signaling device, or may be set by a user ahead of time. Additionally or alternatively, the identifier may be determined based on information received from another device (e.g. transcription device 112 or a remote computing device). For instance, user account information associated with a particular user may be provided to the signaling device. As another example, the identifier may be determined based on information provided during the transcription session. For instance, at the beginning of the transcription session, users may provide identifying information (e.g. a name, an ID number, etc.) to respective signaling devices.

In some implementations, the signal may be associated with the first identifier by nature of one or more attributes of the signal. For instance, signals of particular frequencies may be associated with particular identities (e.g. signals with frequencies in a first frequency range may be associated with a first identity, signals with frequencies in a second frequency range may be associated with a second identity, etc.). As another example, signals with particular patterns of intensity modulation may be associated with particular identities (e.g. signals with a constant intensity may be associated with a first identity, signals with an intensity which alternates between a maximum and minimum value at a particular frequency may be associated with a second identity, etc.).

In some implementations, the system can encode information in the signal. For instance, the first signal may be encoded with the first identifier itself, or with information which can be used to retrieve the first identifier (e.g. from the transcription device 112 or from a remote computing device). In some implementations, the system may additionally or alternatively include other information about the first user or the first signaling device in the information encoded in the at least one first signal. As an example, the system may encode time distance of arrival (TDOA) localization information in the first signal.

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform selected aspects of method 410, 420, and/or to implement one or more aspects of signaling device 122 or transcription device 112. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a CD-ROM drive, an optical drive, or removable media cartridges. Modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple buses.

Computer system 510 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In a first aspect, a method implemented by one or more processors is provided and includes: receiving audio data that captures a spoken utterance of a first user, the audio data being generated by one or more microphones of a transcription device and being received while at least one first signal is received by the transcription device, wherein the at least one first signal is rendered by a first signaling device responsive to a determination that the first user is speaking, and wherein the transcription device and the first signaling device are physically distinct; generating a transcription based on performance of automatic speech recognition on the audio data, the transcription comprising recognized text from the spoken utterance of the first user; annotating the transcription to indicate that the recognized text from the spoken utterance of the first user is associated with a first identifier corresponding to the at least one first signal based at least in part on receiving the audio data while receiving the at least one first signal; and providing the annotated transcription for output.

These and other implementations of technology disclosed herein can optionally include one or more of the following features.

In some implementations, the method may further include: receiving additional audio data that captures a spoken utterance of a second user, the additional audio data being generated by the one or more microphones of the transcription device and being received while at least one second signal is received by the transcription device, wherein the at least one second signal is rendered by a second signaling device responsive to a determination that the second user is providing the spoken utterance, wherein generating the transcription is further based on performance of automatic speech recognition on the additional audio data, and the transcription further includes recognized text from the spoken utterance of the second user; and annotating the transcription, to indicate that the recognized text from the spoken utterance of the second user is associated with a second identifier corresponding to the at least one second signal, based at least in part on receiving the additional audio data while receiving the at least one second signal.

In some implementations, the method may further include: receiving additional audio data that captures a spoken utterance of a second user, the additional audio data being generated by the one or more microphones of the transcription device and being received without the at least one first signal being received by the transcription device; responsive to receiving the additional audio data without the at least one first signal being received by the transcription device, preventing inclusion of any recognized text from the spoken utterance of the second user in the annotated transcription.

In some versions of those implementations, preventing inclusion of any recognized text from the spoken utterance of the second user in the annotated transcription may include determining to bypass performance of automatic speech recognition on the additional audio data.

In some implementations, the method may further include: receiving additional audio data that captures a spoken utterance of a second user, the additional audio data being generated by the one or more microphones of the transcription device and being received without the at least one first signal being received by the transcription device, wherein generating the transcription is further based on performance of automatic speech recognition on the additional audio data, and the transcription further includes recognized text from the spoken utterance of the second user; and annotating the transcription to indicate that the recognized text from the spoken utterance of the second user is not associated with the first identifier, based at least in part on receiving the additional audio data without receiving the at least one first signal.

In some implementations, receiving the at least one first signal by the transcription device may include detecting an audio signal emitted by one or more hardware speakers of the first signaling device. In some versions of those implementations, the audio signal is captured in the audio data, and the method may further include filtering the audio data to remove the audio signal from the audio data for the automatic speech recognition. In some additional or alternative versions of those implementations, the audio signal is inaudible to humans.

In some implementations, receiving the at least one first signal by the transcription device may include detecting a visual indicator output by an interface of the first signaling device.

In some implementations, the method may further include determining, based on information encoded in the at least one first signal, that the at least one first signal is associated with the first identifier.

In some implementations, the first identifier is associated with one or both of the first signaling device and the first user.

In some implementations, the method may further include determining the first identifier based on a previous spoken utterance from the first user received while receiving the at least one first signal, the previous spoken utterance comprising content indicative of the first identifier for the first user.

In some implementations, the method may further include determining, based on information encoded in the at least one first signal, time distance of arrival (TDOA) localization information, wherein annotating the transcription to indicate that the recognized text from the spoken utterance of the first user is associated with the first identifier corresponding to the at least one first signal is further based on the TDOA localization information.

In some implementations, the one or more microphones of the transcription device may include a plurality of spatially distributed microphones, and the method may further include determining, based on a relative signal strength of the received audio data received at each one of the plurality of spatially distributed microphones, a direction from which the audio data was received.

In some versions of those implementations, annotating the transcription to indicate that the recognized text from the spoken utterance of the first user is associated with the first identifier corresponding to the at least one first signal is further based on the direction. In some further versions of those implementations, annotating the transcription to indicate that the recognized text from the spoken utterance of the first user is associated with the first identifier corresponding to the at least one first signal based on the determined direction may include: determining a signal direction from which the at least one first signal was received; and determining that the determined direction from which the audio data was received and the determined signal direction from which the at least one first signal was received are within a threshold difference from each other.

In some additional or alternative versions of those implementations, the method may further include annotating the transcription to indicate that the recognized text from the spoken utterance of the first user was received from the determined direction.

In some implementations, the at least one first signal is received by the transcription device when a beginning and/or an end of the audio data that captures the spoken utterance is received.

In some implementations, generating the transcription may include translating the recognized text from the spoken utterance of the first user into a different language.

In some implementations, providing the annotated transcription for output may include rendering the annotated transcription on a display interface. In some versions of those implementations, the annotated transcription is rendered on the display interface in a streaming manner. In some additional or alternative implementations, the recognized text from the spoken utterance of the first user is rendered to include a first color associated with the first identifier. In some additional or alternative implementations, the method may further include: determining a confidence that the spoken utterance of the first user is associated with the first identifier; determining an intensity of a first color associated with the first identifier, the intensity being determined according to the determined confidence; and causing the recognized text from the spoken utterance of the first user to be rendered with the first color at the determined intensity. In some additional or alternative implementations, the method may further include: determining a confidence that the spoken utterance of the first user is associated with the first identifier and determining a confidence that the spoken utterance of the first user is associated with a second identifier, wherein the first identifier is associated with a first color and the second identifier is associated with a second color, different from the first color; and causing the color of the recognized text from the spoken utterance of the first user to be rendered as a mixture of the first color and the second color based on the determined confidences.

In some implementations, the method may further include: determining that the first user is a member of a first conversational cluster from among a plurality of conversational clusters based on determining that a spoken utterance of at least one other user overlaps with an earlier spoken utterance of the first user for at least a first threshold period of time; and annotating the transcription to indicate that the recognized text from the spoken utterance of the first user is part of the first conversational cluster. In some of those implementations, determining that the first user is a member of a first conversational cluster is further based on one or both of a determined distance or direction of the first user. In some additional or alternative versions of those implementations, the method may further include: determining that the first user has become a member of a second conversational cluster; and annotating the transcription to indicate that recognized text from subsequent spoken utterances of the first user received after the first user has been determined to be a member of the second conversational cluster is part of the second conversational cluster.

In a second aspect, a method implemented by one or more processors is provided, and includes: receiving, based on sensor data received from one or more sensors of a signaling device and/or an auxiliary device in communication with the signaling device, an indication that a first user is speaking; and responsive to receiving the indication that the first user is speaking, rendering, by the signaling device, at least one signal associated with a first identifier, wherein the at least one signal causes a transcription device, receiving the at least one signal and the spoken utterance, to associate the spoken utterance with the first identifier.

These and other implementations of technology disclosed herein can optionally include one or more of the following features.

In some implementations, the method may further include: processing, by the auxiliary device, the sensor data from the one or more sensors to determine that the first user is speaking; and responsively receiving, by the signaling device and from the auxiliary device, the indication that the first user is speaking.

In some implementations, the method may further include: processing, by the signaling device, the sensor data from the one or more sensors to determine that the first user is speaking; and responsively receiving, by the signaling device, the indication that the first user is speaking.

In some implementations, the method may further include: receiving, based on additional sensor data received from the one or more sensors, an indication that the first user is no longer speaking; and causing the rendering of the at least one signal to stop, and/or rendering at least one second signal to indicate that the user is no longer providing the spoken utterance.

In some implementations, the sensor data may include one or more of: audio data generated by one or more microphones, infrared data, vibration data, and movement data.

In some implementations, the at least one signal may include an audio signal emitted by a hardware speaker of the signaling device. In some versions of those implementations, the audio signal is inaudible to humans.

In some implementations, the at least one signal may include a visual indicator provided by an interface of the signaling device.

In some implementations, one or more attributes of the at least one signal are associated with one or both of the signaling device and the first user.

In some implementations, the at least one signal is encoded to carry identification information associated with one or both of the signaling device and the first user. In some versions of those implementations, the identification information is received from the transcription device during a setup procedure. In some additional or alternative implementations, the at least one signal is encoded to carry time distance of arrival (TDOA) localization information.

In a third aspect, a transcription device is provided and includes: at least one processor; and memory storing instructions that, when executed, cause the at least one processor to perform operations corresponding to any one of the methods of the first aspect.

In a fourth aspect, a signaling device is provided and includes: at least one processor; and memory storing instructions that, when executed, cause the at least one processor to perform operations corresponding to any one of the methods of the second aspect.

In a fifth aspect, a system is provided and includes the transcription device of the third aspect and the signaling device of the fourth aspect.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

1. A method implemented by one or more processors, the method comprising:
receiving audio data that captures a spoken utterance of a first user, the audio data being generated by one or more microphones of a transcription device and being received while at least one first signal is received by the transcription device, wherein the at least one first signal is rendered by a first signaling device responsive to a determination that the first user is speaking, and wherein the transcription device and the first signaling device are physically distinct;
generating a transcription based on performance of automatic speech recognition on the audio data, the transcription comprising recognized text from the spoken utterance of the first user;
annotating the transcription to indicate that the recognized text from the spoken utterance of the first user is associated with a first identifier corresponding to the at least one first signal based at least in part on receiving the audio data while receiving the at least one first signal; and
providing the annotated transcription for output.

2. The method of claim 1, further comprising:
receiving additional audio data that captures a spoken utterance of a second user, the additional audio data being generated by the one or more microphones of the transcription device and being received while at least one second signal is received by the transcription device, wherein the at least one second signal is rendered by a second signaling device responsive to a determination that the second user is providing the spoken utterance, wherein generating the transcription is further based on performance of automatic speech recognition on the additional audio data, and the transcription further comprises recognized text from the spoken utterance of the second user; and
annotating the transcription, to indicate that the recognized text from the spoken utterance of the second user is associated with a second identifier corresponding to the at least one second signal, based at least in part on receiving the additional audio data while receiving the at least one second signal.

3. The method of claim 1, further comprising:
receiving additional audio data that captures a spoken utterance of a second user, the additional audio data being generated by the one or more microphones of the transcription device and being received without the at least one first signal being received by the transcription device;
responsive to receiving the additional audio data without the at least one first signal being received by the transcription device, preventing inclusion of any recognized text from the spoken utterance of the second user in the annotated transcription.

4. The method of claim 3, further comprising:
wherein preventing inclusion of any recognized text from the spoken utterance of the second user in the annotated transcription comprises determining to bypass performance of automatic speech recognition on the additional audio data.

5. The method of claim 1, further comprising:
receiving additional audio data that captures a spoken utterance of a second user, the additional audio data being generated by the one or more microphones of the transcription device and being received without the at least one first signal being received by the transcription device, wherein generating the transcription is further based on performance of automatic speech recognition on the additional audio data, and the transcription further comprises recognized text from the spoken utterance of the second user; and
annotating the transcription to indicate that the recognized text from the spoken utterance of the second user is not associated with the first identifier, based at least in part on receiving the additional audio data without receiving the at least one first signal.

6. The method of claim 1, wherein receiving the at least one first signal by the transcription device comprises detecting an audio signal emitted by one or more hardware speakers of the first signaling device.

7. The method of claim 6, wherein the audio signal is captured in the audio data, the method further comprising:
filtering the audio data to remove the audio signal from the audio data for the automatic speech recognition.

8. The method of claim 6 er claim 7, wherein the audio signal is inaudible to humans.

9. The method of claim 1, wherein receiving the at least one first signal by the transcription device comprises detecting a visual indicator output by an interface of the first signaling device.

10. The method of claim 1, further comprising:
determining, based on information encoded in the at least one first signal, that the at least one first signal is associated with the first identifier.

11. The method of claim 1, wherein the first identifier is associated with one or both of the first signaling device and the first user.

12. The method of claim 1, further comprising:
determining the first identifier based on a previous spoken utterance from the first user received while receiving the at least one first signal, the previous spoken utterance comprising content indicative of the first identifier for the first user.

13. The method of claim 1, further comprising determining, based on information encoded in the at least one first signal, time distance of arrival (TDOA) localization information, wherein annotating the transcription to indicate that the recognized text from the spoken utterance of the first user is associated with the first identifier corresponding to the at least one first signal is further based on the TDOA localization information.

14. The method of claim 1, wherein the one or more microphones of the transcription device comprise a plurality of spatially distributed microphones, further comprising:
determining, based on a relative signal strength of the received audio data received at each one of the plurality of spatially distributed microphones, a direction from which the audio data was received.

15. The method of claim 14, wherein annotating the transcription to indicate that the recognized text from the spoken utterance of the first user is associated with the first identifier corresponding to the at least one first signal is further based on the direction.

16. The method of claim 15, wherein annotating the transcription to indicate that the recognized text from the spoken utterance of the first user is associated with the first identifier corresponding to the at least one first signal based on the determined direction comprises:
determining a signal direction from which the at least one first signal was received; and
determining that the determined direction from which the audio data was received and the determined signal direction from which the at least one first signal was received are within a threshold difference from each other.

17. The method of claim 14, further comprising:
annotating the transcription to indicate that the recognized text from the spoken utterance of the first user was received from the determined direction.

18. The method of claim 1, wherein the at least one first signal is received by the transcription device when a beginning and/or an end of the audio data that captures the spoken utterance is received.

19. The method of claim 1, wherein generating the transcription further comprises translating the recognized text from the spoken utterance of the first user into a different language.

20-27. (canceled)

28. A method implemented by one or more processors, the method comprising:
receiving, based on sensor data received from one or more sensors of a signaling device and/or an auxiliary device in communication with the signaling device, an indication that a first user is speaking; and
responsive to receiving the indication that the first user is speaking, rendering, by the signaling device, at least one signal associated with a first identifier, wherein the at least one signal causes a transcription device, receiving the at least one signal and the spoken utterance, to associate the spoken utterance with the first identifier.

29-42. (canceled)
